(19) United States
(12) Patent Application Publication
(10) Pub. No.: US 2013/0282419 A1
(43) Pub. Date: Oct. 24, 2013

(54) GOAL-ORIENTED PLANNING SYSTEM

(71) Applicants: Rohan Martin Braddy, Glen Iris (AU); Philip Richard Lange, Coburg (AU); Warren William Yates, Tarneit (AU)

(72) Inventors: Rohan Martin Braddy, Glen Iris (AU); Philip Richard Lange, Coburg (AU); Warren William Yates, Tarneit (AU)

(21) Appl. No.: 13/537,656

(22) Filed: Jun. 29, 2012

(30) Foreign Application Priority Data
Apr. 23, 2012 (AU) 2012901592

(51) Int. Cl. G06Q 10/06

(52) U.S. Cl. 705/7.15

(57) ABSTRACT

A computer-implemented method and system monitors progress of a participant in a program of development. At least one development goal is established for the participant, and a corresponding record created in a database and associated with a participant record. At least one objective is established, recorded and associated with the development goal record. At least one activity is selected, contributing to achievement of the development goal. A roster is created, in which the participant is scheduled to participate in the selected activity under supervision of at least one supervisor. Upon completion of a rostered activity, the system presents the supervisor with a reporting interface configured for entry of participant progress information with respect to achievement of the objective and the development goal. The supervisor enters progress information relating to the objective and/or the development goal, and the system stores this information in the database in association with the participant record.

### RELATED PATENT DOCUMENT

This patent document claims the benefit, under 35 U.S.C. §119(a), of Australian Provisional Patent Application No. 2012901592 filed on Apr. 23, 2012, and entitled “Goal-Oriented Planning System,” which is fully incorporated herein by reference.

### FIELD OF THE INVENTION

The present invention relates broadly to resource management, and more particularly to computer-aided methods and systems for monitoring and managing progress of individuals involved in programs of development.

### BACKGROUND OF THE INVENTION

Many individuals within society are participants in development programs of various types, such as education programs, life skills development programs, vocational training programs, and programs to pursue personal interests and entertainment.

In programs which are highly individualised, problems may arise in recording and monitoring progress of participants. Individualised programs of development may comprise unique combinations of goals and objectives, which are achieved at a pace which is highly dependent upon the capabilities and motivation of the participant. Areas in which highly individualised programs are common and/or desirable include health care, disability support and rehabilitation.

In many countries, including Australia, such programs are substantially supported by public funding. Receipt of public funds typically brings a level of accountability which in turn creates an enhanced requirement for good record-keeping and monitoring of participant progress.

Disability support programs, in particular, may be run by a variety of independent service providers in the community, each of which may employ a number of trained staff who supervise and assist participants in the program. In such environments, especially if staff have heavy workloads, consistency and regularity of reporting and monitoring of participant progress may be difficult to regulate. With an increasing emphasis in policy and regulation upon needs-based funding, such record-keeping may be of particular importance to ensure that participants in development programs are adequately supported.

In addition to meeting accountability standards, it is highly desirable that staff have easy access to relevant and up-to-date information regarding the progress of individual participants in their care.

An object of the present invention is therefore to provide an improved, computer-based, method and system for recording and monitoring the progress of participants in these and other types of development program, which facilitates a high level of flexibility for managing individualised programs and activities.

### SUMMARY OF THE INVENTION

In one aspect, the invention provides a computer-implemented method of monitoring progress of a participant in a program of development, the method comprising steps of:

establishing at least one development goal for the participant, creating a record of the development goal in a database, and associating the development goal record with a participant record stored in the database;

establishing at least one objective to be achieved by the participant in order to achieve the development goal, creating a record of the objective in the database, and associating the objective record with the development goal record;

selecting at least one activity contributing to achievement of the development goal, and associating the activity with the goal in the database;

creating a roster in which the participant is scheduled to participate in the selected activity under supervision of at least one supervisor;

upon completion of a rostered activity, presenting to the supervisor on a computer display a reporting interface configured for entry of participant progress information with respect to achievement of the objective and the development goal, the interface being generated using contents of the participant record, the goal record, and the objective record in the database;

receiving from the supervisor, via the reporting interface, participant progress information with respect to achievement of the objective and/or the development goal; and

storing the received participant progress information in the database in association with the participant record.

Advantageously, embodiments of the inventive method significantly automate, simplify and formalise the processes of planning, monitoring and recording progress of the participant in an individualised program of development. The method enables formal goals to be established for participants, objectives to be set which contribute to those goals, and activities to be scheduled which assist the participants in achieving the objectives. Formal recording of this information in a database ensures that it can be made available to supervisors for monitoring and reporting purposes. Participant activities and progress are tied to a roster, which may be reviewed both prior and subsequent to the running of scheduled activities. This assists supervisors in managing and monitoring the participants in their care, and facilitates consistent and regular reporting. Provision of a specific reporting interface, in particular, may significantly simplify and formalise the entry of progress information, feedback, and other details of participant engagement, support and behaviour.

Storage of all of this information in the database also facilitates ongoing monitoring and reporting of participant progress, involvement in development activities, relevance and purpose of those activities, and achievements of goals and objectives, which may assist in meeting regulatory requirements, consistently recording and accounting for staff time and other costs, and/or supporting funding requests.

In embodiments of the method, a maximum number of active development goals is imposed for the participant. For example, it may be unrealistic to expect a participant to be working towards more than four goals simultaneously, and the computer-implemented method may therefore place such a limitation on the number of goals that may be established at any one time.

It may similarly be desirable that a maximum number of objectives is imposed for each development goal established for the participant. It might be, for example, that a maximum of four objectives towards achieving each goal is considered appropriate.

In embodiments of the invention, the development goal is associated with one or more predetermined categories of development. For example, within the particular context of providing disability or rehabilitation support programs within the Australian system, there may be two predetermined categories of development, i.e. the Department of Human Services (DHS) Service Standard, and the ‘Life Area’ classifications.

In an embodiment of the invention, the reporting interface includes a plurality of selectable achievement levels for the objective, and the step of receiving participant progress information includes receiving a selection of one of the selectable achievement levels. For example, a number of discrete selectable achievement levels may be provided, varying from a minimum (i.e. starting) level, up to a maximum level at which the objective is achieved.

Generally, a development goal is achieved when all objectives associated with the development goal in the database are achieved.

In an embodiment of the invention, the reporting interface is further configured for entry of participant progress information relating to one or more levels of support required by the participant in completing the rostered activity, and the step of receiving participant progress information includes receiving from the supervisor, via the reporting interface, a selection in relation to the one or more support levels.

In an embodiment, the reporting interface is further configured for entry of participant progress information relating to an apparent level of participant engagement in, and/or enjoyment of, the rostered activity, and the step of receiving participant progress information includes receiving from the supervisor, via the reporting interface, a selection in relation to the apparent level of participant engagement in, and/or enjoyment of, the rostered activity.

In an embodiment, the reporting interface is further configured for entry of free-form text notes relating to participant involvement in the rostered activity, and the step of receiving participant progress information includes receiving from the supervisor, via the reporting interface, free-form text input.

It is desirable that additional reporting functions are provided, in accordance with embodiments of the invention. In this regard, an embodiment of the inventive method further includes steps of:

providing an administration interface configured to enable an operator to request generation of one or more reports based upon information held in the database;

receiving a request from the operator to generate a report;

retrieving from the database information relating to supervisors, participants, activities, goals and/or objectives which is relevant to the requested report;

generating the requested report; and

outputting the generated report.

Outputting of the generated report may comprise displaying, printing and/or transmitting the report.

In an embodiment, available reports are selected from a group comprising: activity-based reports; participant-based reports; and supervisor-based reports.

In another aspect, the invention provides a computer-based system for monitoring progress of a participant in a program of development, the system comprising:

a processor;

a database accessible via the processor;

at least one storage device, operatively associated with the processor;

at least one output device, operatively associated with the processor; and

at least one input device, operatively associated with the processor,

wherein the database contains records including at least:
a participant record;
a development goal record associated with the participant record;
one or more objective records associated with the development goal record;
one or more activity records associated with the development goal record; and
an activity roster in accordance with which the participant is scheduled to participate in at least one activity under supervision of at least one supervisor,

wherein the storage device contains computer-executable program instructions which, when executed by the processor, cause the system to perform the steps of:
upon completion of an activity in accordance with the activity roster, presenting to the supervisor via the output device a reporting interface configured for entry of participant progress information with respect to achievement of the objective and the development goal, the interface being generated using contents of the participant record, the goal record and the objective record in the database;
receiving from the supervisor, via the input device, participant progress information with respect to achievement of the objective and/or the development goal; and
storing the received participant progress information in the database in association with the participant record.

In one embodiment, the input device and output device comprise at least one network interface device, wherein the reporting interface is presented to the supervisor at a remote computing device via a connected data network, and participant progress information is received from the remote computing device via the data network. In a particular implementation, the computer-based system comprises a web server, and the remote computing device operated by the supervisor comprises conventional web browser software for accessing the server.

In an embodiment, the computer-executable program instructions further include instructions which, when executed by the processor, cause the system to perform steps of:

providing, via the output device, an administration interface configured to enable an operator to request generation of one or more reports based upon information held in the database;

receiving, via the input device, a request from the operator to generate a report;

retrieving from the database information relating to supervisors, participants, activities, goals and/or objectives which is relevant to the requested report;

generating the requested report; and

outputting, via the output device, the generated report.

Further features and advantages of the invention will be apparent from the following description of a particular embodiment, which is provided by way of example only, and does not limit the generality of any of the preceding statements, or of the scope of the invention as defined by the claims appended hereto.

### BRIEF DESCRIPTION OF THE DRAWINGS

An exemplary embodiment will now be described with reference to the accompanying drawings, in which like reference numerals refer to like features, and wherein:

FIG. 1 is a block diagram illustrating a networked system within which embodiments of the present invention may be implemented;

FIG. 2 is a block diagram showing further details of a server configured to implement a goal-oriented planning, monitoring and reporting system according to an embodiment of the invention;

FIG. 3 is a schematic diagram of database content according to an embodiment of the invention;

FIG. 4 is a flowchart illustrating a method of monitoring progress of a participant in a program of development, according to an embodiment of the invention;

FIG. 5 is a flowchart illustrating a reporting method according to an embodiment of the invention;

FIG. 6 shows an exemplary web-based interface screen for viewing and updating participant information;

FIG. 7 shows an exemplary web-based interface screen for creating, viewing and editing development goals;

FIG. 8 shows an exemplary web-based interface screen for adding an objective;

FIG. 9 shows exemplary web-based interface elements for linking activities to goals;

FIG. 10 shows an exemplary web-based interface screen for accessing a roster;

FIGS. 11A and B show exemplary web-based interface screens representing two alternative views of rostered activities;

FIG. 12 shows an exemplary web-based interface screen for viewing a goal summary report;

FIG. 13 shows an exemplary web-based user interface screen for entry of participant progress information; and

FIGS. 14A to D illustrate exemplary reports generated by an embodiment of the invention.

### DETAILED DESCRIPTION OF EMBODIMENTS

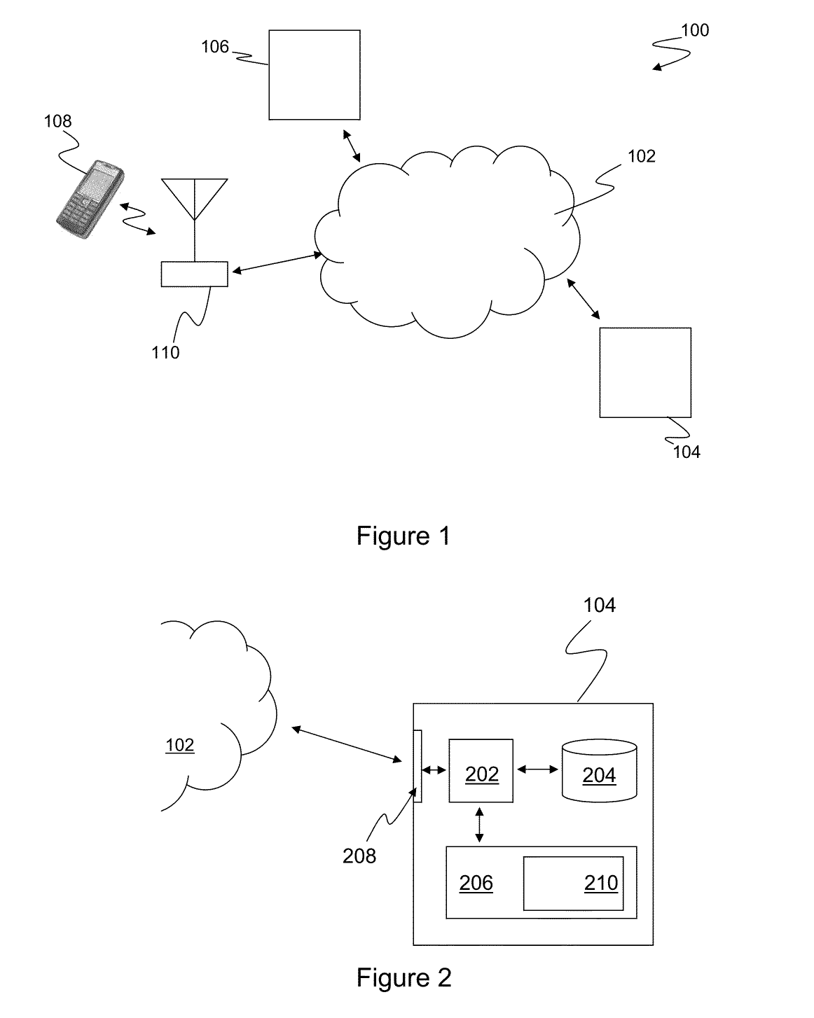

FIG. 1 is a block diagram illustrating a system 100 within which embodiments of the present invention may be implemented.

The system 100 uses a communications network 102, e.g. the Internet and/or a corporate intranet, to provide a goal-oriented planning, monitoring and reporting system to staff and other users within one or more organisations. In the exemplary embodiment described here, the particular application for which the system is deployed relates to the provision of disability support programs and/or other community-based healthcare or rehabilitation programs. In this context, participants in the program are clients of the organisation, which operates various activities under supervision of suitably trained or qualified staff for personal development, education, training and so forth, of the clients. The trained staff act as supervisors to clients during scheduled activities, monitoring and reporting on client progress towards a set of defined goals and objectives. The purpose of the system is thus to assist and support the staff in this task, to encourage and track regular and consistent recording of feedback on client progress, and to facilitate reporting and accountability.

It will be understood, however, that the application of embodiments of the present invention is not limited to this exemplary case, which is provided by way of illustration only. The general principles, features and facilities of embodiments of the invention are applicable to a wide range of development programs, including education programs, life skills development programs, vocational training programs, and programs directed to personal interests, activities and entertainment.

Services of the system are provided to staff via a server computer 104. Staff may access the server 104 via client computers 106, e.g. using conventional web browser software, or from mobile devices 108, employing either web-browser software or custom-designed mobile applications (‘apps’).

In the exemplary embodiment, the server 104 executes a web server software application for provision of services via devices 106, 108. Communication between the server 104 and the devices 106, 108 is thus conveniently based upon standard Hypertext Transfer Protocol (HTTP) and/or Secure Hypertext Transfer Protocol (HTTPS). However, other means of communication between the server 104 and devices 106, 108 will also be apparent to persons skilled in the relevant art. Furthermore, standalone implementations, based upon application software executing on one or more of the devices 104, 108, with either local or remote data storage, are also feasible. All such variations which would be apparent to persons skilled in the relevant computer programming arts, are within the scope of the present invention.

Mobile devices 108 access the network 102 via access points 110. The wireless access points 110 may be, for example, wireless LAN (Wi-Fi) access points, or cellular mobile access points. The use of wireless devices 108, such as notebook or tablet PCs, may provide particular convenience for staff working at facilities which are located remotely from the server 104.

As will be appreciated by persons skilled in the communications arts, various mechanisms and technologies are available to provide access to the Internet 102 from fixed and mobile devices 106, 108, and are within the scope of the present invention.

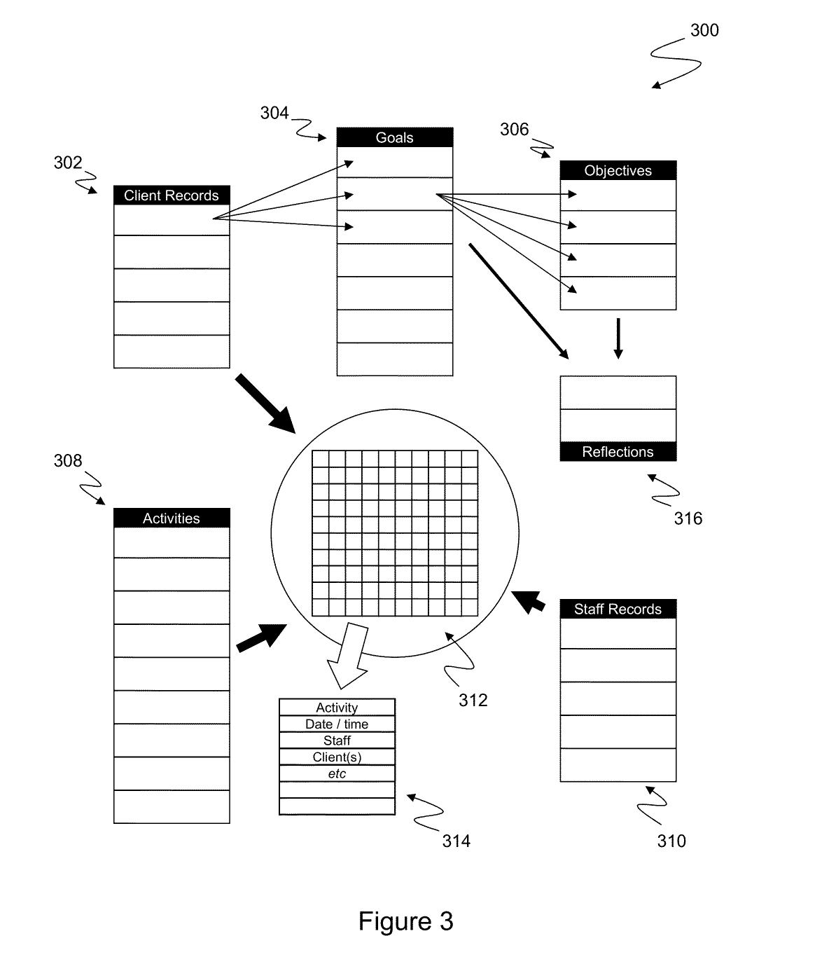

FIG. 2 is a block diagram showing further details of the server system 104.

The server 104 may generally comprise one or more computers, each of which includes at least one microprocessor 202. The number of computers and processors 202 generally depends upon the required processing capacity of the system, which in turn depends upon the number of concurrent user devices 106, 108 requiring access to the server 104. In the case of a small-to-medium community-based service provider, as envisaged in the exemplary embodiment, a single server computer will typically suffice.

However, for larger organisations, or applications in which the service is provided to multiple organisations via a central computing facility, a collection or ‘farm’ of server computers may be co-located, or geographically distributed and interconnected via the Internet 102. For even greater scalability, a third-party cloud computing platform may be employed for implementation of the server 104, thereby enabling the physical hardware resources to be allocated dynamically in response to service demand. These and other variations are within the scope of the present invention, even though the exemplary embodiment described herein uses only a single server computer 104 with a single microprocessor 202.

The microprocessor 202 is interfaced to, or otherwise operably associated with, a non-volatile memory/storage device 204. The non-volatile storage 204 may be a hard-disk drive, and/or may include solid-state non-volatile memory such as Read Only Memory (ROM), flash memory, or the like. The microprocessor 202 is also interfaced to volatile storage 206, such as Random Access Memory (RAM), which contains program instructions and transient data relating to the operation of the server 104. In a conventional configuration, the storage device 204 maintains known program and data content relevant to the normal operation of the computer system. For example the storage device 204 may contain operating systems programs and data, as well as other executable application software necessary to the intended functions of the server 104. In the embodiment shown, the storage device 204 also contains program instructions which, when executed by the processor 202, enable the server computer 104 to perform operations relating to the implementation of services and facilities embodying the present invention. In operation, instructions and data held on the storage device 204 are transferred to volatile memory 206 for execution on-demand.

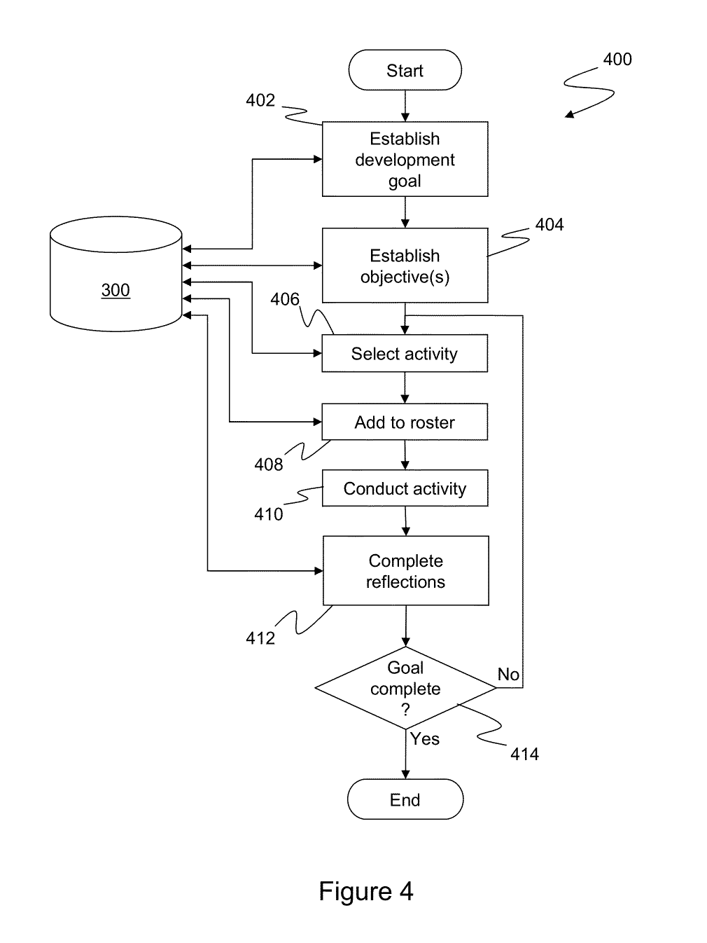

The microprocessor 202 is also operably associated with a network interface 208 in a conventional manner. The network interface 208 facilitates access to one or more data communications networks, including the Internet 102, which are employed for communication between the server 104 and user devices 106, 108. In use, the volatile storage 206 includes a corresponding body 210 of program instructions configured to perform processing and operations embodying features of the present invention, comprising various steps in the processes and functions described below with reference to FIGS. 3 to 14.

In the presently described embodiment, the program instructions 210 include instructions embodying a web server application. Data stored in the non-volatile 204 and volatile 206 storage comprises web-based code for presentation and/or execution on user devices 106, 108, such as HTML and/or JavaScript code, facilitating a web-based implementation of a goal-oriented planning, monitoring and reporting system.

A central feature of the exemplary embodiment is a database containing records relating to participants (i.e. clients), client development goals, client objectives, activities conducted by the operating organisation, and supervisors (ie. staff of the operating organisation). The database may also be used to maintain a roster of activities, including associated supervisors and clients. Further, the database may also be used to store participant progress information entered by supervisors upon completion of activities.

A schematic diagram of the database 300, showing the various record contents, is illustrated in FIG. 3. It should be appreciated that the exemplary database structure 300 is schematic in nature, and need not represent the true internal organisation of any particular implementation, which may be based upon a variety of widely available database technologies. The purpose of the schematic diagram of database content 300 is to illustrate the key information held within the database, and some of the important relationships between the various records containing that information.

As illustrated, the database 300 includes participant records 302. The participant records 302 include personal details and contact information of clients. Clients attending facilities operated by the support program service provider each have specific goals which they are seeking to achieve by participation in the available programs. Records of these goals 304 are also stored in the database, and are associated with the corresponding participant records 302.

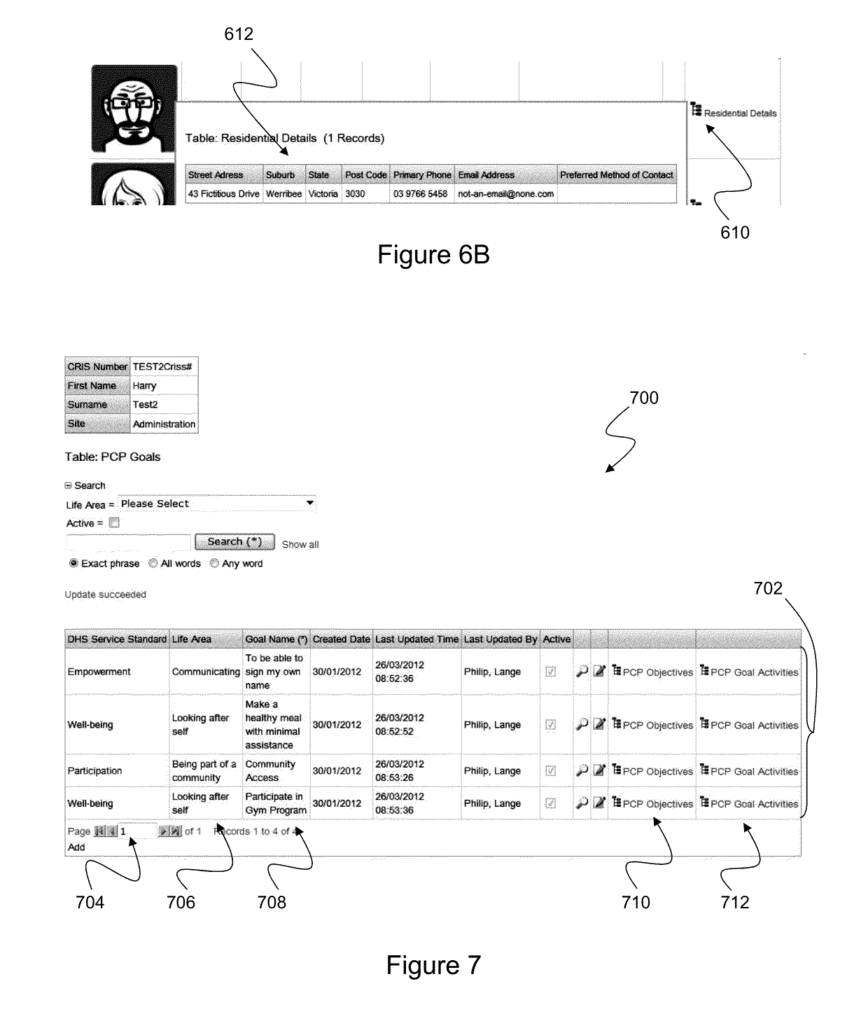

The achievement of each goal in turn requires the achievement of one or more associated objectives, which are represented in the database 300 by objectives records 306. Mechanisms of entering and viewing participant records, goal records, and objectives records are described below with reference to FIGS. 6 to 8.

The database 300 also includes a set of records 308 representing available activities conducted by the operating organisation. The database 300 also contains records 310 of the available supervisors (i.e. staff). Activities 308 may be scheduled to take place at various times, under the supervision of one or more staff 310, and involve the participation of one or more clients 302. A roster 312, which may also be recorded within the database 300, maintains the schedule of activities, and associated staff and clients. An entry 314 within the roster 312 therefore contains a record of the activity, the date and time at which it is conducted, identifiers of the supervisors running the activity, and identifiers of the participants expected to attend.

The database 300 also includes records 316 containing client progress information which is recorded by supervisors in relation to each participant upon completion of a scheduled activity. In the context of the exemplary embodiment, the progress information is also referred to as ‘reflections’, and the records 316 thus contain reflections data.

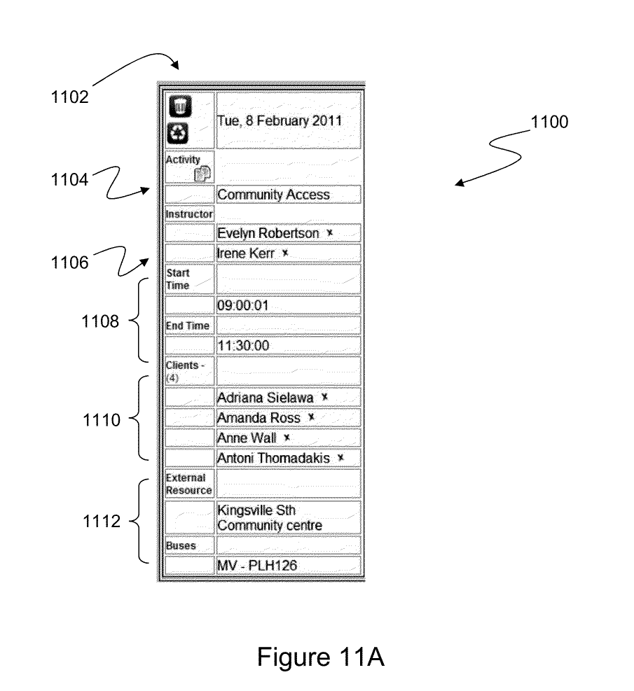

Processes for linking activities 308 to clients 302, scheduling activities in the roster 312, and entering reflections data 316, are described below with reference to FIGS. 9 to 13.

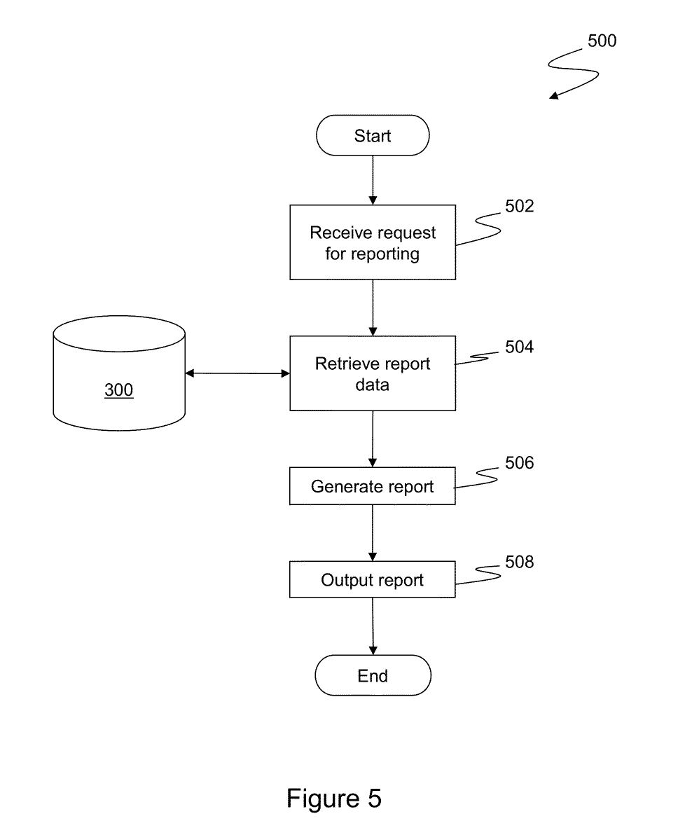

FIG. 4 shows a flowchart 400 which illustrates a general process by which the server 104 is employed to implement a method of monitoring progress of a client through a program of development involving various goals and objectives, through participation in scheduled activities.

It will be appreciated that the flowchart 400 represents only one very simple sequence of steps, in order to illustrate the overall operation of the computer-implemented method and system. In a practical environment, the method represented by the flowchart 400 may be replicated many times, corresponding with different clients, and also corresponding with multiple different activities, goals and objectives which each individual client may be involved with at a given point in time.

For practical reasons, and to achieve positive outcomes without overloading clients, the system implemented on the server 104 will generally impose limits upon the number of scheduled activities, the number of simultaneous goals, and the number of objectives, being pursued by each client. For example, in one implementation each client is permitted to have no more than four goals at any one point in time, and each goal is permitted to have no more than four associated objectives. Of course, these limits may be varied in different embodiments, in order to suit specific requirements.

Steps in the method 400 access and/or update information held in the database 300.

At step 402, at least one development goal is established for a client. This includes the creation of a corresponding development goal record 304 associated with the client record 302.

At step 404, one or more objectives is established in association with the goal. This involves the creation of corresponding objectives records 308 within the database 300.

At step 406, one or more activities are selected from those available and represented by activities records 308. The selected activities will generally contribute to the achievement of goals 304, to which they are linked.

At step 408, at least one selected activity is added to the roster 312. At the corresponding scheduled time, the activity takes place 410, under supervision of an associated staff member having a corresponding record 310 in the database 300.

Once the activity has concluded, the supervising staff member is responsible for completion of reflections 412 regarding the progress of the client as reflected through their participation in the scheduled activity.

In a typical case, if the goal is not yet completed 414 further relevant activities will be scheduled to assist the client in progressing towards achievement of the various objectives, and thus the overall goal. Once that goal has been achieved, it can be made inactive, and a new goal established for the client.

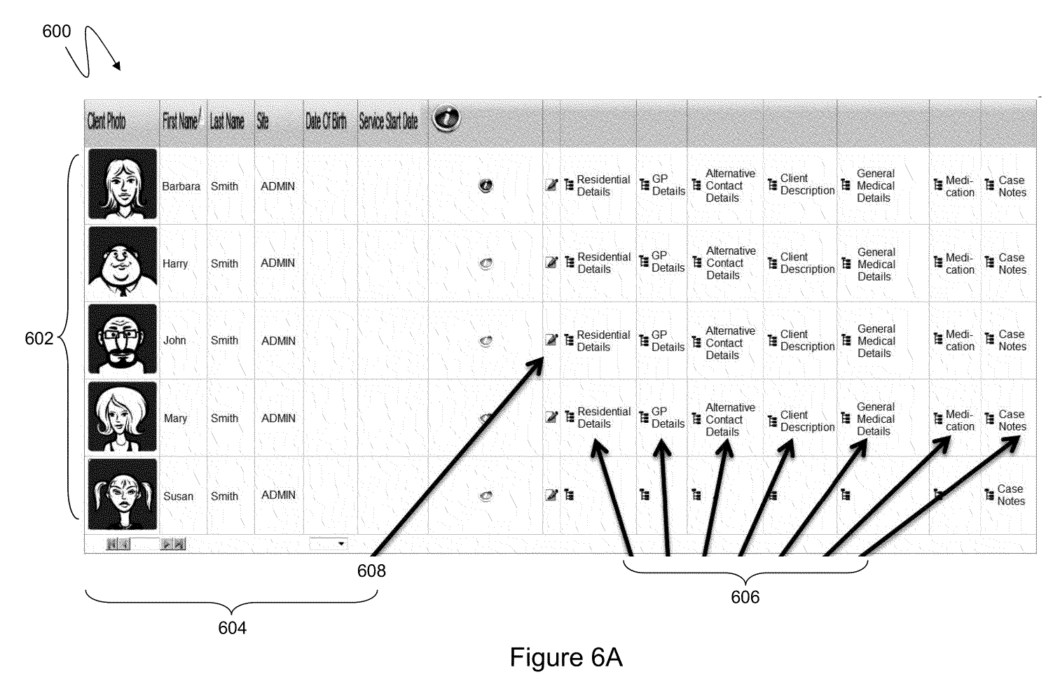

FIG. 5 is a flowchart 500 which illustrates a reporting method implemented in the exemplary embodiment. As will be appreciated, information which is recorded in the database 300 may be used for the purposes of tracking, monitoring and reporting a wide range of data pertinent to the ongoing operations of the organisation. Information held in the database 300 includes details of staff and clients, details of rostered activities, times when those activities were conducted, which staff supervised, the staff time and other resources associated with the activities, the outcomes, the progress of clients towards their goals and objectives, and a range of other information that may be recorded in association with the staff, client and activity records. Reports of this information may be used for a variety of purposes, including planning, accounting, and providing feedback on client progress.

According to the reporting method 500 the server 104 receives a request for reporting at step 502. This request will typically be made by a user, such as a staff member, selecting one or more report options from an administration interface provided via the web server.

At step 504, the data relevant to the requested report is retrieved from the database 300. This data is then used to generate the report at step 506.

Finally, at step 508, the report is output. Reports may be output to the screen of the user, or may be made available for download for subsequent printing, storage and/or transmission. Reports may be generated in HTML, PDF format, an editable document format (such as Word or Excel), or any other convenient format as may be required.

Further use and operation of the web-based system embodying the invention will now be described with reference to FIGS. 6 to 14.

FIG. 6A shows an exemplary web-based interface screen 600 for viewing and updating participant information. The display 600 includes a number of rows 602, each of which corresponds with a client of the operating organisation. Each row includes a number of columns, the first ones of which 604 display personal information such as the client's name, the particular site of the organisation with which the client is associated, their date of birth, and the date on which they commenced use of the organisation's services.

Columns 606 to the right of the display 600 contain links associated with additional content relating to the clients. The additional content includes residential details, medical details, alternative contact details, descriptive information, medications, case notes, and so forth.

A dedicated editing link 608 is provided to bring up an interface element, e.g. a dialog box, enabling the core information in the left-hand columns to be viewed and edited, including a photo of the client, which appears in the first column. With regard to the further content, in the exemplary embodiment hovering over one of the links 606 causes a pop-up box to appear showing the corresponding content. This is exemplified in FIG. 6B, in which hovering over the ‘residential details’ link 610 causes the corresponding residential details record to be displayed 612. Alternatively, clicking on each link will bring up a separate interface element, such as a dialog box, enabling the corresponding content to be viewed and/or edited.

All of the information available via the display 600 corresponds with details stored in the associated client records 302 within the database 300.

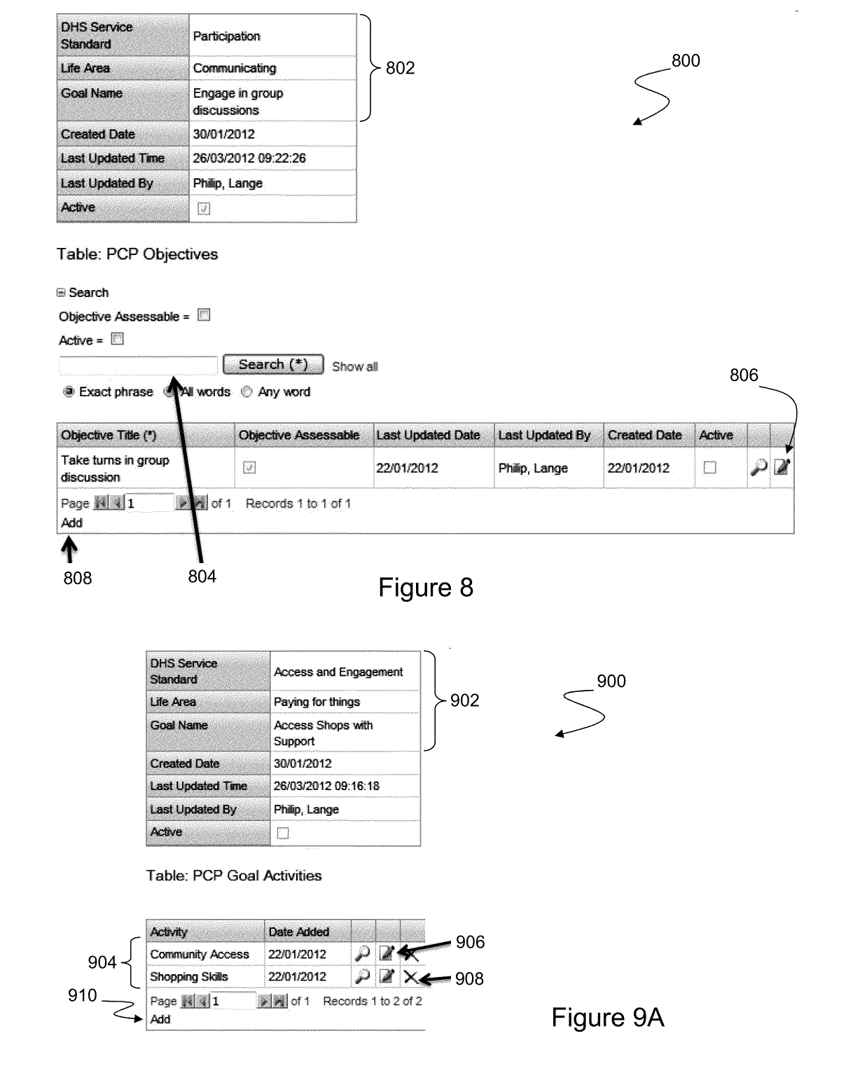

FIG. 7 shows an exemplary web-based interface screen 700 for creating, viewing and editing development goals, corresponding with step 404 in the flowchart 400. In the exemplary embodiment, the user arrives at the screen 700 via a ‘goals and objectives’ link in the web-based interface, which then presents a searchable list of clients, each of which may be selected in order to bring up the corresponding goals display 700.

In the example shown, the selected client has four active goals, shown in the table rows 702. In the exemplary case, which relates to the Australian operating environment, each of the goals 702 is associated with two categories 704, 706, being the ‘DHS Service Standard’ and ‘Life Area’ corresponding with the goal. Thus, for example, the goal of ‘to be able to sign my own name’ is associated with the Service Standard of ‘empowerment’, and the Life Area of ‘communicating’. As can be seen, the goal name is listed in the column 708.

Links are provided within each row 702 in order to view and/or edit the objectives 710 associated with each goal, and the activity 712 linked to each goal.

The details of the goals shown in the rows 702 are stored within goal records 304 within the database 300.

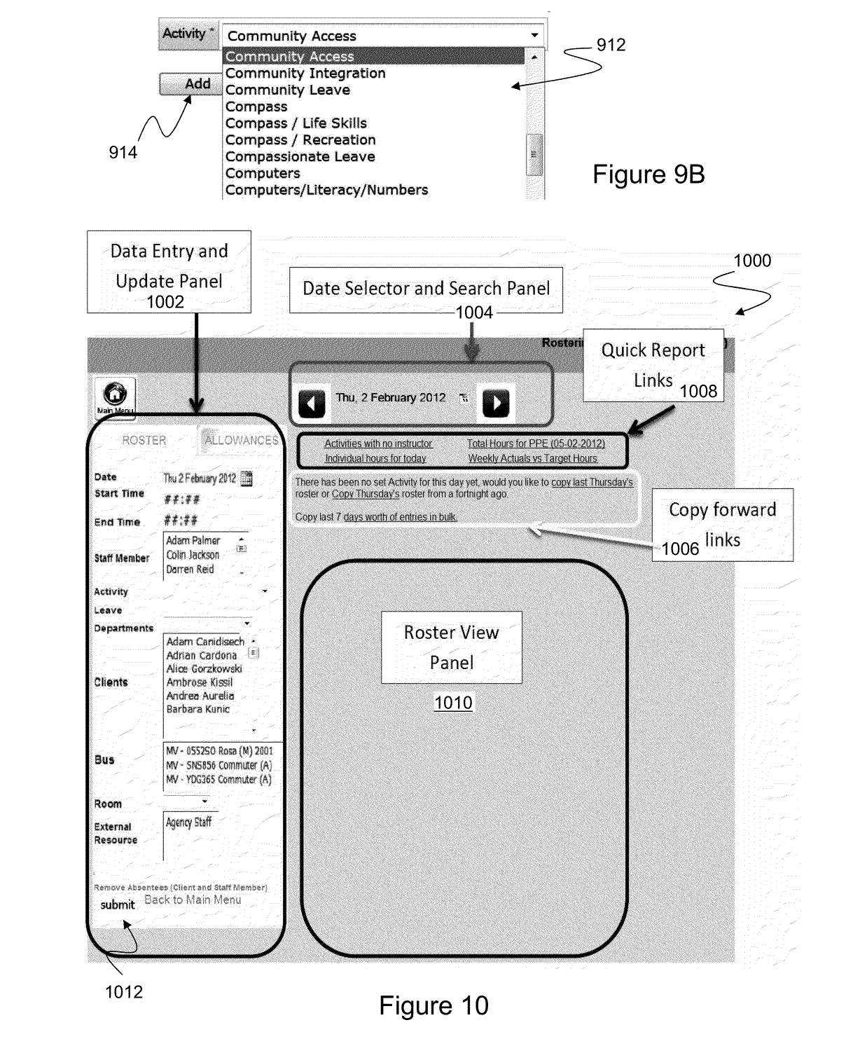

FIG. 8 shows an exemplary web-based interface screen for adding an objective, which is accessed by clicking on the corresponding objectives link 710 in the goals screen 700. The example 800 shown, as can be seen from the display area 802, relates to the goal ‘engage in group discussions’, corresponding with the Service Standard ‘participation’, and the Life Area ‘communicating’. A search box 804 is provided to enable the user to search for specific objectives, which may be useful in the case of a longstanding client who may have a large number of past and present objectives.

In the display 800 a single objective 806 is currently associated with the goal. This is the objective to ‘take turns in group discussion’. New objectives may be added by clicking on the ‘add’ link 808.

Objectives 806 are stored within objectives records 308 within the database 300, associated with their corresponding goal records 304.

FIG. 9 shows exemplary web-based interface elements 900, 912 for linking activities to goals. The relevant display elements are called up by clicking on the corresponding goal activities link 712 in the display 700.

The display element 900 allows the user to view activities associated with a goal. In this case, as shown in the portion 902 of the main table, the goal is to ‘access shops with support’, corresponding with the service standard ‘access and engagement’, and life area ‘paying for things’.

Two activities are currently listed, shown in the rows 904 of the Activity Table. Activities can be edited by clicking on the element 906, or deleted by clicking on the element 908. New activities may be added by clicking on the ‘add’ link 910, which calls up the further interface elements 912.

In particular, the element 912 is a drop-down list corresponding with the available activity record 308 held in the database 300. The user is thus enabled to select any of the available activities which will contribute to achievement of the selected goal, and its associated objectives. When an activity has been selected from the drop-down list 912, it can be linked to the selected goal by clicking the ‘add’ button 914.

Once a client has been given one or more goals and associated objectives, and at least one activity has been linked to these goals and objectives, participation of the client in the linked activities can be scheduled. Scheduling is done via the roster 312, which is maintained within the database 300. Particular activities, taking place at scheduled dates and times, are supervised by available staff, each of which also has a record 310 within the database 300. A scheduled activity in the roster 312 therefore generally has an associated date and time, associated staff/supervisors, and associated participants selected from the clients to whom the activity has been linked via one of their corresponding goals.

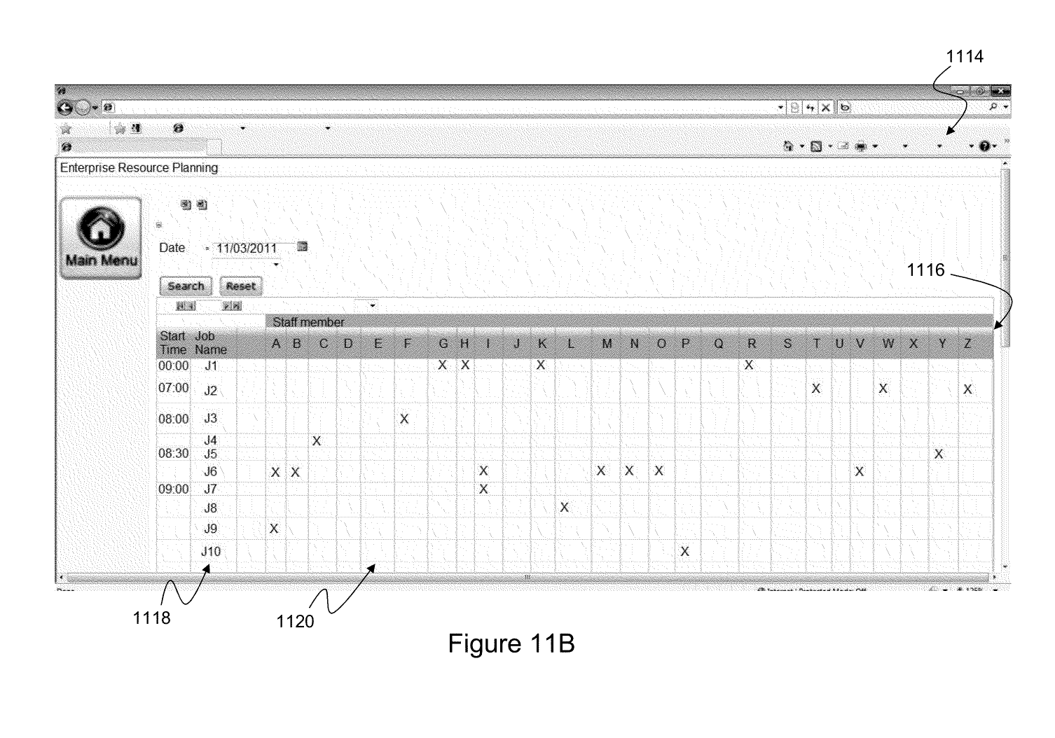

An exemplary web-based interface screen 1000 for accessing the roster is illustrated in FIG. 10. The screen 1000 comprises five main display areas or panels.

The data entry and update panel 1002 includes user interface elements for entering dates and times of activities, selecting staff members to supervise the activities, specifying the particular activities, selecting the clients who will participate in the activity, specifying additional resources required for activity, such as transportation, rooms and so forth, and for entering any other details which may be required.

A date selector and search panel 1004 enables a date to be chosen, for viewing of a corresponding portion of the roster 312.

A further panel 1006 facilitates standard copying functions within the roster 312. For example, many activities are held at regular times on a weekly or fortnightly basis, and it is therefore useful, rather than re-entering information, to have a facility for duplication of corresponding days from prior weeks.

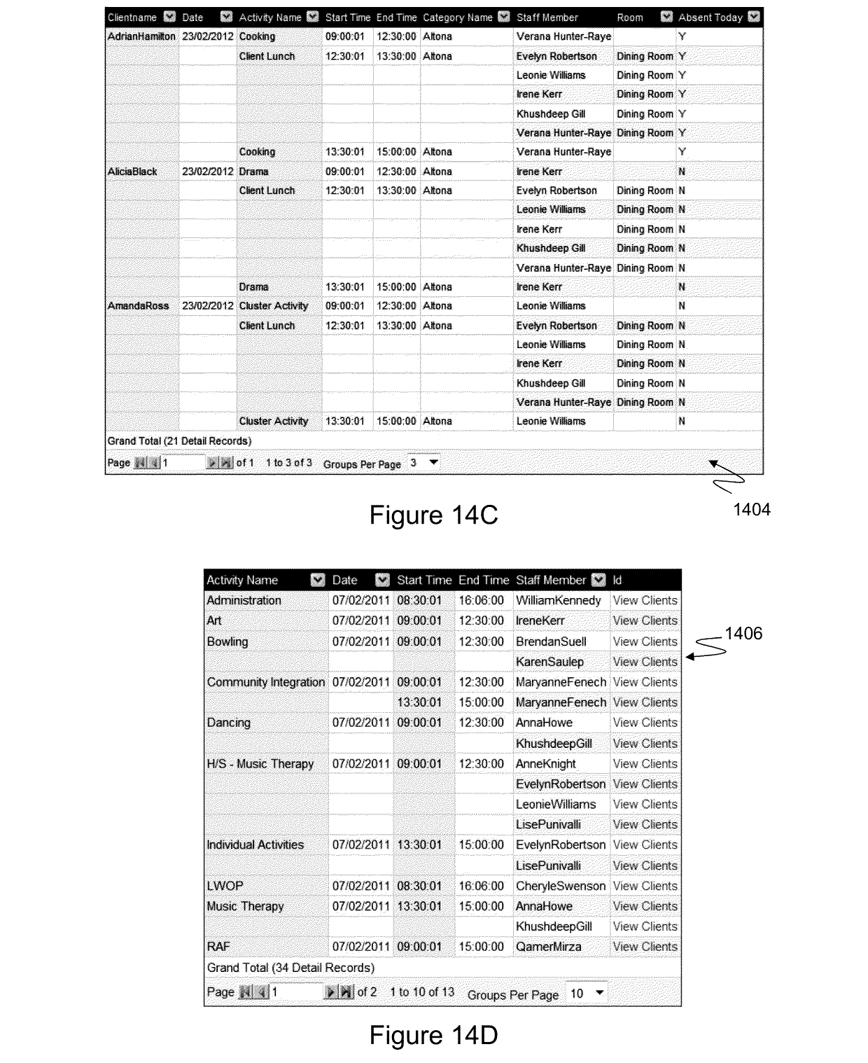

A further panel area 1008 contains a number of links to provide rapid access to reporting, as described in greater detail below with reference to FIGS. 14A to D.

Finally, a large region of the display 1000 is allocated to the roster view panel 1010, which is the area in which information from the roster 312 is displayed.

Roster entries 314 are initially created by entering the relevant data into the entry panel 1002, and clicking on the ‘submit’ link 1012.

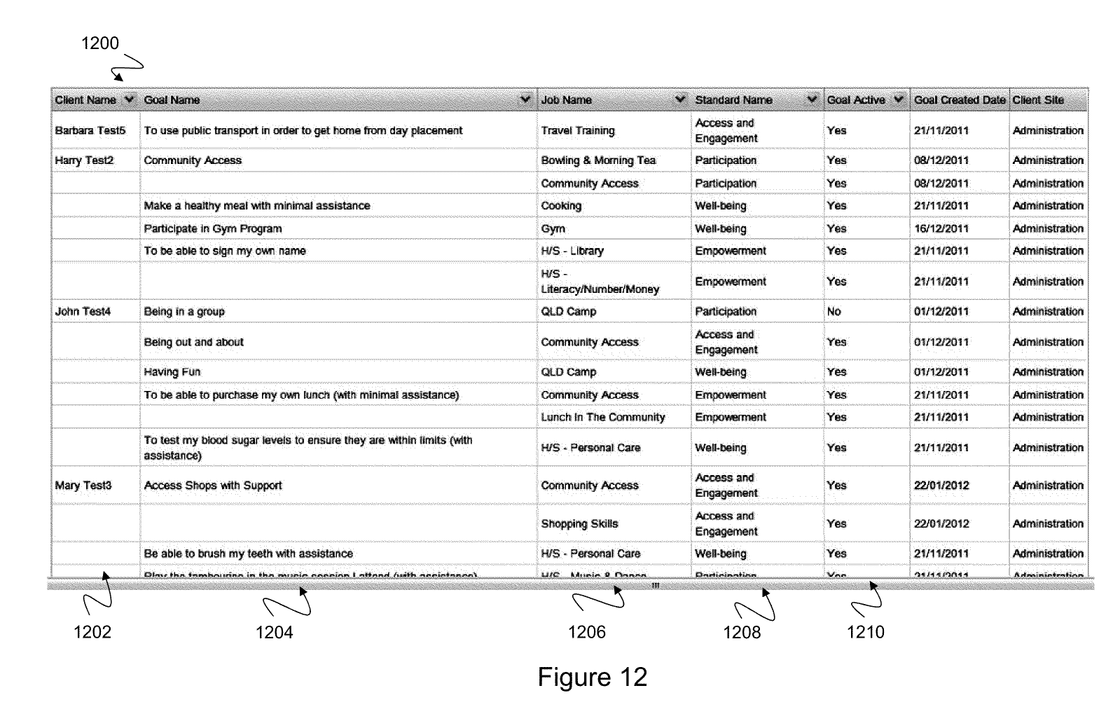

FIG. 11A shows a first exemplary web-based interface screen 1100 for viewing a rostered activity 1102. The display element 1102 appears within the roster view panel 1010, upon selection of the corresponding date using the date selector 1004.

Within the element 1102 the user is able to review the name of the activity 1104, the staff responsible for instructing or supervising the activity 1106, the start and end times 1108, the clients scheduled to participate 1110, and identifying information of external resources, transportation and so forth 1112.

An alternative graphical roster display 1114 is illustrated in FIG. 11B. The graphical display 1114 is useful for obtaining an overview of activities and staff assignments. A table is displayed having staff members listed across the top 1116, and rostered activities identified by time and location down the left-hand side 1118. This results in a grid 1120, in which staff rostered to particular activities are identified with a cross. This enables the schedules, availability, and locations of staff to be identified rapidly.

In the exemplary embodiment, provision is made for special ‘activities’, corresponding with alternative status of staff and/or participants, such as absence on annual leave, or sick leave. Although these are not true activities, their inclusion enables the unavailability of staff due to these events to be incorporated into a single roster view. Provision is also made for activities such as administration and record-keeping tasks, to enable all staff time to be recorded.

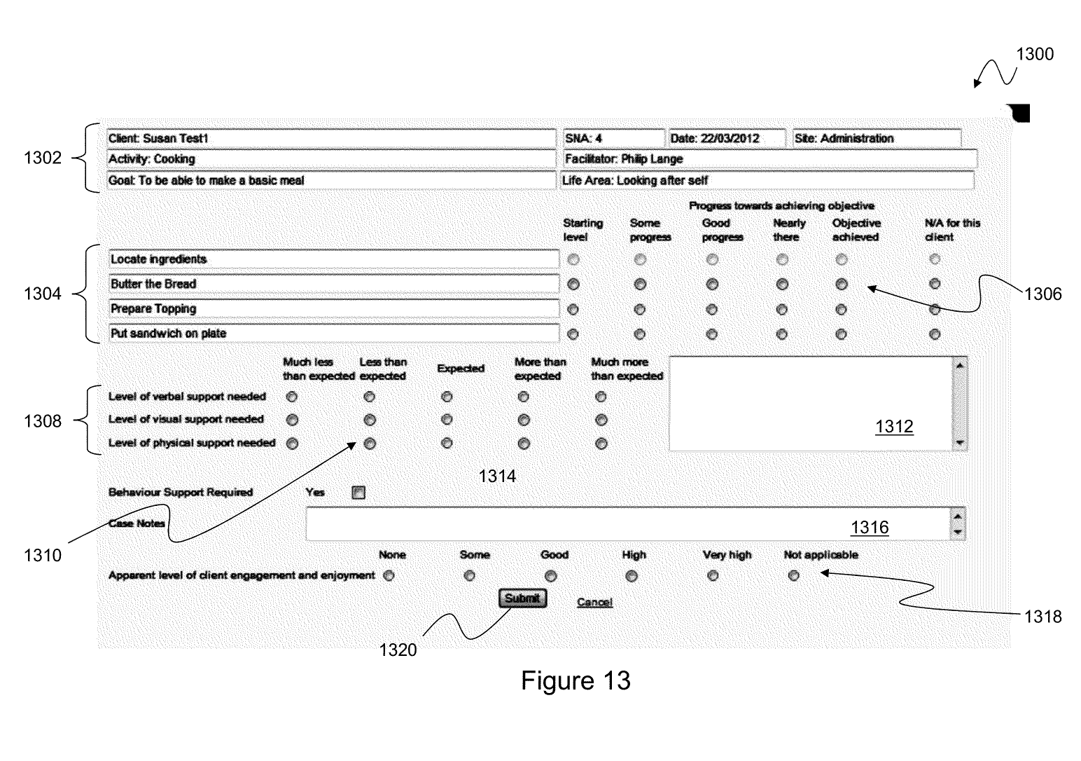

Once clients have records 302 in the system, and corresponding goals 304 and objectives 306 have been allocated, the exemplary system enables a user to bring up a goal summary report, as illustrated in the display 1200 shown in FIG. 12. The goal summary report 1200 is accessed via a ‘goal summary’ link within the main user interface provided by the server, which allows these to select one or more sites within the overall organisation, and bring up the report corresponding with client goals and objectives for the selected sites.

The goal summary report 1200 includes a number of rows and columns. The rows correspond generally with clients, their goals and objectives, as listed within the specific columns.

The left-most column 1202, contains client names. These are followed by the corresponding client goals 1204, activities 1206, the corresponding Standard 1208, and a status indicator 1210 as to whether the goal is currently active or not. Various other information associated with the clients and their goals may be incorporated into the table 1200, and the table may itself be configurable, for example to add, remove, and/or reorder columns. As will be appreciated, the information summarised in the report 1200 is drawn from the participant records 302, goal records 304, objective records 306, and linked activities 308, held within the database 300.

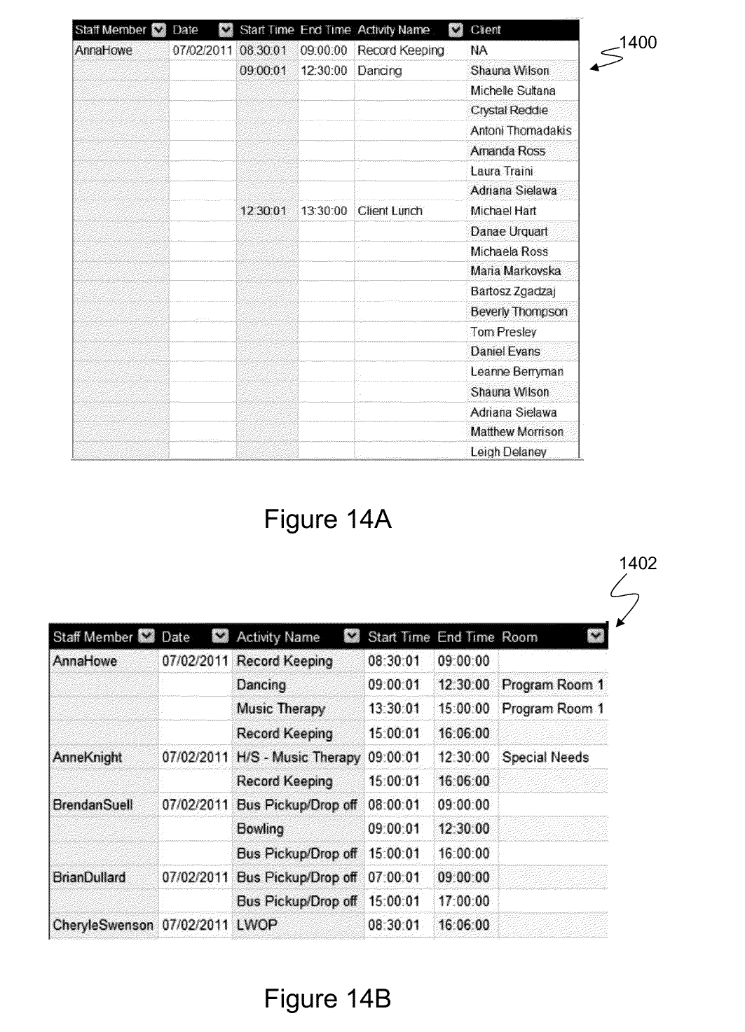

FIG. 13 shows an exemplary web-based user interface screen for entry of client progress information, i.e. facilitating the reporting step 412. As noted above, within the exemplary embodiment this is known as ‘reflection’.

The reflection screen 1300 is called up by a supervisor in relation to each participant/client after completion of an activity. A number of specific user interface elements within the reflection screen 1300 enable rapid, consistent and regular reporting of progress and significant notes and events.

An upper region of the reflection screen 1300 includes information 1302 relating to the client, the activity, and the goal. Below this, associated objectives 1304 are listed. Alongside each objective is a set of radio buttons 1306, each of which represents a level of progress towards achieving the objective. The supervisor is thus able to quickly evaluate, and enter, relevant progress information, which can also then easily be tracked over time.

Below this, interface elements are provided to enable the supervisor to provide feedback on levels of verbal, visual and physical support required by the client during the activity. This information may be valuable to identify specific improvements in client capabilities, or the emergence of problems indicated by the requirement for higher levels of support than expected. Again, radio buttons 1310 are provided to enable rapid assessment and completion of the relevant information. A free-text entry pane 1312 is also provided, into which the supervisor may enter any relevant notes or comments, in order to expand upon the ratings provided using the radio buttons 1310.

A check box 1314 is provided to enable the supervisor to indicate if behaviour support was required during the activity.

A further text entry box 1316 is provided for entry of any relevant case notes. Finally, a further set of radio buttons 1318 is provided for the supervisor to enter an evaluation of the apparent level of client engagement and enjoyment during the activity.

Once the information in the reflections screen 1300 is completed, the supervisor clicks on the ‘submit’ button 1320, which causes the entered information to be committed to the database 300 in the form of a new reflections data records 316.

Further reporting functions of the exemplary system are illustrated in FIGS. 14A to D. These reports are accessible, for example, via the quick-report links 1008 in the roster interface 1000.

The first exemplary report is a staff-based report 1400. The staff-based report lists staff members at a selected site, the rostered activities for which they were responsible, and the clients who participated, or are scheduled to participate, in those activities.

In view of the fact that there may be a large number of clients involved in particular activities, a shorter staff-based report 1402 is provided as an alternative, which does not include the clients. This enables a more rapid overview of the activities of staff members over a specified period of time.

A further exemplary report which is available is the client-based report 1404. This report shows all of the clients at a selected site, the activities in which they were/are involved, and the corresponding supervising staff members.

A fourth exemplary report is an activity-based report 1406, in which staff and clients may be reviewed relative to activities in which they were/are involved.

In the exemplary embodiment, each of the reports 1400, 1402, 1404, 1406 provides a filtering facility, enabling the contents of the report to be restricted and/or sorted by different criteria, and also provides export functions, for example to common application formats such as Microsoft Word or Microsoft Excel.

As will be appreciated, all of the information required for each of the exemplary reports is drawn from the database 300, including participant records 302, staff records 310, activity records 308, and information 314 held in the roster 312.

As will be appreciated from the foregoing description, a particular strength of embodiments of the invention is the way in which participants, goals, objectives, activities and supervising staff are all linked via a roster created and managed within the database 300. The system overall ensures that participant goals and objectives are clear, that activities are selected which contribute to those goals and objectives, and that progress information is provided in respect of all participants in all activities by supervising staff in a timely, consistent and regular manner.

This integration enables a variety of advantageous facilities to be provided. For example, all relevant staff hours are recorded within the system, which is convenient for accounting, charging, and reporting functions.

Participation of clients within activities is recorded and tracked, and progress maintained, enabling improvements and/or any problems which may arise, to be quickly identified.

Various modules may be implemented to carry out one or more of the operations and activities described herein and/or shown in the figures. In these contexts, a “module” is a circuit that carries out one or more of these or related operations/activities (e.g., generate image interface data, store data in association with other data (e.g., via location or data modification/tags), filter data based on association of the data with a record). For example, in certain of the above-discussed embodiments, one or more modules are discrete logic circuits or programmable logic circuits configured and arranged for implementing these operations/activities, as in the circuit modules shown in FIGS. 1 and 2 (e.g., computer-based modules at 104). In certain embodiments, the programmable circuit is one or more computer circuits programmed to execute a set (or sets) of instructions (and/or configuration data). The instructions (and/or configuration data) can be in the form of firmware or software stored in and accessible from a memory (circuit). As an example, certain association and filtering modules include a combination of a CPU hardware-based circuit and a set of instructions accessed from a memory circuit.

Accordingly, various embodiments are directed to an apparatus having an input device, an output device, a data storage circuit, and modules including an interface module, association module and filer module. The data storage circuit includes, for each of a plurality of participant records in which each record corresponds to a single participant, a development goal record associated with the participant record, at least one objective record and activity record associated with each development goal record, and an activity roster identifying at least one participant activity to be performed under supervision of at least one supervisor, each activity having one of the activity records assigned thereto. The interface module operates with the data storage circuit (e.g., by accessing data stored therein) to generate a reporting interface in response to data indicating the completion of one of the participant activities in accordance with an activity roster for a participant. The reporting interface is generated using contents of the participant record, the development goal record and the objective record for the participant, and present the reporting interface via the output device. The interface module also receives, via the input device, participant progress information with respect to achievement of at least one of the objective and the development goal. The association module associates the received participant progress information with the participant record from which the reporting interface was generated, and stores, in the data storage circuit, the received participant progress information in association with the participant record. The filter module filters data based on the stored received participant progress information and the association of the progress information with a participant record, generates an interface using the filtered data, and presents the interface via the output device.

In some embodiments, the filter module is a computer processor configured and arranged with the data storage circuit to generate the interface by generating a visual interface displayable to a user via a computer display. The visual interface depicts the development goal record and the at least one objective record associated with the development goal record for a single participant record, the one or more activity records associated with the development goal record, and the activity roster for the participant record.

In other embodiments, the filter module operates with the data storage circuit to generate the reporting interface by accessing development goal and objective records for a plurality of participant records pertaining to a common activity record, and generates an interface depicting accessed records therein providing access to disparate participant records corresponding to a common activity. Using this approach, various records associated with specific participants can be integrally accessed, therein readily facilitating insight into certain activities across multiple participants.

In some embodiments, the association module is a computer processor that stores the received participant progress information in association with the participant record. This association may be effected, for example, by storing the received progress information in a storage location designated to the participant record, and/or by modifying data corresponding to the received progress information with data that associates the received progress information with the participant record.

Certain embodiments are directed to a computer program product involving a non-volatile memory device, which includes a machine or computer-readable medium having stored thereon instructions which may be executed by a computer (or other electronic device) to perform these operations/activities.

As changes in policy and regulation inevitably require more-conscientious record-keeping, greater accountability, and the allocation of funding on a needs basis, embodiments of the present invention provide an extremely useful and powerful tool within the fields of healthcare, disability support and rehabilitation. However, the flexible, integrated, goal-oriented planning, monitoring and reporting system provided by embodiments of the present invention is not limited to these areas of endeavour.

Accordingly, while particular embodiments and variations of the invention have been described herein, further modifications and alternatives will be apparent to persons skilled in the relevant art. Accordingly, the described embodiments are not limiting of the scope of the invention, which is defined in the claims which follow.

1. An apparatus comprising:
an input device;
an output device;
a data storage circuit including, for each of a plurality of participant records in which each record corresponds to a single participant,
a development goal record associated with the participant record,
at least one objective record and activity record associated with each development goal record, and
an activity roster identifying at least one participant activity to be performed under supervision of at least one supervisor, each activity having one of the activity records assigned thereto;
an interface module configured and arranged with the data storage circuit to
in response to data indicating the completion of one of the participant activities in accordance with an activity roster for a participant, generate a reporting interface using contents of the participant record, the development goal record and the objective record for the participant, and present the reporting interface via the output device, and
receive, via the input device, participant progress information with respect to achievement of at least one of the objective and the development goal;
an association module configured and arranged to
associate the received participant progress information with the participant record from which the reporting interface was generated, and
store, in the data storage circuit, the received participant progress information in association with the participant record; and
a filter module configured and arranged with the data storage circuit to filter data based on the stored received participant progress information and the association of the progress information with a participant record, generate an interface using the filtered data, and present the interface via the output device.

2. The apparatus of claim 1, wherein the filter module is a computer processor configured and arranged with the data storage circuit to generate the interface by generating a visual interface displayable to a user via a computer display, the visual interface depicting
the development goal record and the at least one objective record associated with the development goal record for a single participant record,
the one or more activity records associated with the development goal record, and
the activity roster for the participant record.

3. The apparatus of claim 1, wherein the filter module is configured and arranged with the data storage circuit to generate the reporting interface by accessing development goal and objective records for a plurality of participant records pertaining to a common activity record, and generating an interface depicting accessed records therein providing access to disparate participant records corresponding to a common activity.

4. The apparatus of claim 1, wherein the association module is a computer processor configured and arranged to store the received participant progress information in association with the participant record by at least one of storing the received progress information in a storage location designated to the participant record, and modifying data corresponding to the received progress information with data that associates the received progress information with the participant record.

5. A computer-implemented method of monitoring progress of a participant in a program of development, the method comprising steps of:
establishing at least one development goal for the participant, creating a record of the development goal in a database, and associating the development goal record with a participant record stored in the database;
establishing at least one objective to be achieved by the participant in order to achieve the development goal, creating a record of the objective in the database, and associating the objective record with the development goal record;
selecting at least one activity contributing to achievement of the development goal, and associating the activity with the goal in the database;
creating a roster entry in a roster in which the participant is scheduled to participate in the selected activity under supervision of at least one supervisor, wherein the roster entry comprises at least a record of the selected activity, the date and time at which the selected activity is scheduled to be conducted, an identifier of the participant, and an identifier of the at least one supervisor;
upon completion of a selected activity having a record in the roster entry, presenting to the supervisor on a computer display a reporting interface configured for entry of participant progress information with respect to achievement of the objective and the development goal, the interface being generated using contents of the participant record, the goal record, and the objective record in the database;
receiving from the supervisor, via the reporting interface, participant progress information with respect to achievement of at least one of the objective and the development goal; and
storing the received participant progress information in the database in association with the participant record.

6. The method of claim 5 wherein establishing at least one development goal for the participant includes establishing a number of development goals that does not exceed a maximum number of active development goals imposed for the participant.

7. The method of claim 5 wherein establishing at least one objective to be achieved by the participant includes establishing a number of objectives that does not exceed a maximum number of objectives imposed for each development goal established for the participant.

8. The method of claim 5 wherein the development goal is associated with at least one predetermined category of development.

9. The method of claim 5 wherein the reporting interface includes a plurality of selectable achievement levels for the objective, and receiving participant progress information includes receiving a selection of one of the selectable achievement levels.

10. The method of claim 5 wherein storing participant progress information includes storing progress information identifying that a development goal is achieved in response to all objectives associated with the development goal in the database being achieved.

11. The method of claim 5 wherein the reporting interface is further configured for entry of participant progress information relating to at least one level of support required by the participant in completing the rostered activity, and receiving participant progress information includes receiving from the supervisor, via the reporting interface, a selection in relation to the at least one support level.

12. The method of claim 5 wherein the reporting interface is further configured for entry of participant progress information relating to an apparent level of participant involvement with the selected activity having a record in the roster entry, and receiving participant progress information includes receiving from the supervisor, via the reporting interface, a selection in relation to the apparent level of participant involvement with the selected activity having a record in the roster entry.

13. The method of claim 5 wherein the reporting interface is further configured for entry of free-form text notes relating to participant involvement in the selected activity having a record in the roster entry, and the step of receiving participant progress information includes receiving from the supervisor, via the reporting interface, free-form text input.

14. The method of claim 5 which further includes steps of:
providing an administration interface configured to enable an operator to request generation of at least one report based upon information held in the database;
receiving a request from the operator to generate a report;
retrieving from the database information relating to at least one of supervisors, participants, activities, goals and objectives which is stored in association with the requested report;
generating the requested report; and
outputting the generated report.

15. The method of claim 14 wherein outputting of the generated report may comprise at least one of displaying, printing and transmitting the report.

16. The method of claim 14 wherein available reports are selected from a group comprising: activity-based reports; participant-based reports; and supervisor-based reports.

17. A computer-based system for monitoring progress of a participant in a program of development, the system comprising:
a processor;
a database accessible via the processor;
at least one storage device, operatively associated with the processor;
at least one output device, operatively associated with the processor; and
at least one input device, operatively associated with the processor,
wherein the database contains records including at least:
a participant record;
a development goal record associated with the participant record;
at least one objective record associated with the development goal record;
at least one activity record associated with the development goal record; and
an activity roster in accordance with which the participant is scheduled to participate in at least one activity under supervision of at least one supervisor,
wherein the storage device contains computer-executable program instructions which, when executed by the processor, cause the system to perform the steps of:
upon completion of an activity in accordance with the activity roster, presenting to the supervisor via the output device a reporting interface configured for entry of participant progress information with respect achievement of the objective and the development goal, the interface being generated using contents of the participant record, the goal record and the objective record in the database;
receiving from the supervisor, via the input device, participant progress information with respect to achievement of at least one of the objective and the development goals; and
storing the received participant progress information in the database in association with the participant record.

18. The system of claim 17 in which the input device and output device comprise at least one network interface device, wherein the reporting interface is presented to the supervisor at a remote computing device via a connected data network, and participant progress information is received from the remote computing device via the data network.

19. The system of claim 18 wherein the computer-based system comprises a web server, and the remote computing device operated by the supervisor comprises conventional web browser software for accessing the server.

20. The system of claim 17 wherein the computer-executable program instructions further include instructions which, when executed by the processor, cause the system to perform steps of:
providing, via the output device, an administration interface configured to enable an operator to request generation of at least one report based upon information held in the database;
receiving, via the input device, a request from the operator to generate a report;
retrieving from the database information relating to at least one of supervisors, participants, activities, goals and objectives that is stored in association with the requested report;
generating the requested report; and
outputting, via the output device, the generated report.

21. A computer-based system for monitoring progress of a participant in a program of development, the system comprising:
a processor;
a database accessible via the processor;
at least one storage device, operatively associated with the processor;
at least one output device, operatively associated with the processor; and
at least one input device, operatively associated with the processor,
wherein the database is configured to contain records including at least:
one or more participant records;
one or more development goal records;
one or more objective records;
one or more activity records; and
an activity roster having one or more roster entries, in accordance with which the participant is scheduled to participate in at least one activity under supervision of at least one supervisor, wherein each roster entry comprises at least a record of the activity, the date and time at which the activity is scheduled to be conducted, an identifier of the participant, and an identifier of the at least one supervisor, and
wherein the storage device contains computer-executable program instructions which, when executed by the processor, cause the system to perform the steps of:
creating a development goal record in the database, corresponding with a development goal established for the participant, and associating the development goal record with a participant record of the participant stored in the database;
creating an objective record in the database, corresponding with an objective to be achieved by the participant in order to achieve the development goal, and associating the objective record with the development goal record;
creating an activity record corresponding with a selected activity contributing to achievement of the development goal, and associating the activity record with the development goal record in the database, whereby the participant is scheduled to participate in the selected activity under supervision of at least one supervisor;
creating a roster entry in the activity roster, wherein the roster entry comprises at least a record of the activity, the date and time at which the activity is scheduled to be conducted, an identifier of the participant, and an identifier of the at least one supervisor;
upon completion of an activity in accordance with the activity roster, presenting to the supervisor via the output device a reporting interface configured for entry of participant progress information with respect to achievement of the objective and the development goal, the interface being generated using contents of the participant record, the goal record and the objective record in the database;
receiving from the supervisor, via the input device, participant progress information with respect to achievement of at least one of the objective and the development goal; and
storing the received participant progress information in the database in association with the participant record.
